(19) United States
(12) Patent Application Publication
(10) Pub. No.: US 2008/0101445 A1
(43) Pub. Date: May 1, 2008

(54) DSL wake-up

(75) Inventors: Che-lin Ho, San Jose, CA (US); Mark Gallagher, Newbury (GB)

Correspondence Address: BLAKELY SOKOLOFF TAYLOR & ZAFMAN, 1279 OAKMEAD PARKWAY, SUNNYVALE, CA, 94085-4040, US

(73) Assignee: Stoke,Inc.

(21) Appl. No.: 11/515,245

(22) Filed: Aug. 31, 2006

(51) Int. Cl. H04B 1/38

(52) U.S. Cl. 375/222

(57) ABSTRACT

A method and apparatus is disclosed herein. In one embodiment, the method comprises receiving data to be forwarded to a device, via a digital subscriber line (DSL) modem, after a previously existing layer three (L3) connection to the DSL modem is no longer set up, where the DSL modem is addressed via an Internet Protocol (IP) address specified in the data, and sending a message to a DSL modem via a secure link to cause the DSL modem to initiate a new L3 connection if the IP address is available from a predetermined location.

### FIELD OF THE INVENTION

The present invention relates to the field of digital subscriber line (DSL) communications; more particularly, the present invention relates to waking up a DSL modem to re-initiate communication between the DSL modem and services.

### BACKGROUND OF THE INVENTION

FIG. 1 illustrates a network arrangement that includes a digital subscriber line (DSL) modem. Referring to FIG. 1, an asynchronous service 100 exchanges data with DSL modem 104. Internet service provider (ISP) 101 communicates with an asynchronous service 100 as well as a broadband remote access server (B-RAS) 102. B-RAS 102 interfaces to a digital subscriber line access multiplexer (DSLAM) 103, which is coupled to a residence 110 that includes DSL modem 104. In one embodiment, DSLAM 103 is coupled to residence 110 via a telephone line, or link, 111 (e.g., a copper line). A link is coupled to DSL modem 104. DSL modem 104 converts the signals received from link 111 into packets that computer 105 understands and converts the packets received from computer 105 into signals that may be sent on link 111.

Communication between asynchronous service 100 and computer 105, via DSL modem 104, occurs while Layer 3 (L3) connection exists between B-RAS 102 and DSL modem 104. This L3 connection is not permanent because the ISP and carriers do not provision an IP-address for every device, such as DSL modem 104, that may utilize the network. This type of provisioning is necessary because some network resources are commodities.

Networks use shared access to allocate use of network resources among a number of users. Some of the resources are commodities. However, there are never enough commodities available to all users in a shared access network. First, there are a low number of ports on DSLAM 103 and B-RAS 102 by which to make physical connections between each other and between ISP 101 and B-RAS 102. That is, there are limited number of ports on the egress side of DSLAM 103 and on both the ingress and the egress side of B-RAS 102 to support all of the potential users using the network all the time. Furthermore, there is limited amounts of available bandwidth. In other words, there is a limited number of physical bits per second that can be sent on the egress of DSLAM 103 as well as the ingress and the egress of B-RAS 102. A third commodity used in shared access is the IP addresses of B-RAS 102. There is a finite set of available addresses that may be used and therefore they must be shared among the users. Fourth, battery life of a mobile device is a commodity as well.

Because of these commodities or constraints, if computer 105 becomes quiescent or gets switched off and goes quiet, the L3 connection and any results associated with the L3 connection are relinquished by B-RAS 102 and devices may be provisioned to use a portion of the network. Therefore, when DSL modem 104 enters the quiet state for a period of time, B-RAS 102 ends the L3 connection and drops the connection. In such a case, an asynchronous service, such as asynchronous service 100, that wants to send data to DSL modem 104 cannot do so.

In the prior art, there are a number of techniques used to prevent an L3 connection from being relinquished. In one case, devices are placed on the network that call or poll the network such that the network believes the computer is still using the connection. Such a method keeps alive the connection by sending empty packets. However, this scheme wastes bandwidth and the resources associated with the network. Also, this technique reduces the battery life of mobile devices because they are sending empty packets.

### SUMMARY OF THE INVENTION

A method and apparatus is disclosed herein. In one embodiment, the method comprises receiving data to be forwarded to a device, via a digital subscriber line (DSL) modem, after a previously existing layer three (L3) connection to the DSL modem is no longer set up, where the DSL modem is addressed via an Internet Protocol (IP) address specified in the data, and sending a message to a DSL modem via a secure link to cause the DSL modem to initiate a new L3 connection if the IP address is available from a predetermined location.

### BRIEF DESCRIPTION OF THE DRAWINGS

The present invention will be understood more fully from the detailed description given below and from the accompanying drawings of various embodiments of the invention, which, however, should not be taken to limit the invention to the specific embodiments, but are for explanation and understanding only.

FIG. 1 illustrates a prior art network arrangement.

FIG. 2 illustrates a network arrangement.

FIG. 3 illustrates a flow diagram of one embodiment of a process performed by a broadband remote access server.

FIG. 4 illustrates a block diagram of one embodiment of a DSL modem.

FIG. 5 illustrates a flow diagram of one embodiment of a process for performing wake-up.

FIG. 6 illustrates a flow diagram of one embodiment of a process for waking up a DSL connection between a DSL modem and a broadband remove access server.

### DETAILED DESCRIPTION OF THE PRESENT INVENTION

A method and apparatus for re-initiating a connection to a digital subscriber line (DSL) modem are disclosed. This enables data (e.g., asynchronous service data) to be forwarded to a computer or other computing device, via the DSL modem, if generated by a service after the network connection to the DSL modem has been dropped. In one embodiment, the method comprises receiving data to be forwarded to the computing device, via the DSL modem, after a previously existing Layer 3 (L3) connection to the DSL modem is no longer set up and sending a message to the DSL modem via a secure link (e.g., a secure Layer 2 (L2) link) to cause the DSL modem to initiate a new L3 connection. In one embodiment, the wake up message causes the DSL modem to initiate point-to-point over Ethernet (PPPoE) protocol negotiations to reestablish an L3 connection. Thereafter, the data can be forwarded to the computing device, via the DSL modem, and the DSL modem may communicate with other parts of the network (e.g., a broadband remote access server (B-RAS), a DSLAM, an Internet Service Provider (ISP) via the network connection.

In one embodiment, a table is used to keep track of the IP address associated with each device (e.g., DSL modem). The table may map the IP address to the MAC address of the device. When data received from an asynchronous service is to be sent to the DSL modem and the L3 connection to the DSL modem is not up, the wake-up table is checked to determine if the address of the DSL modem is contained therein. If so, a message is sent to the DSL modem to cause the DSL modem to re-initiate the L3 connection. Once the connection is back up, the data from the service may be forwarded through the DSL modem to another device.

In the following description, numerous details are set forth to provide a more thorough explanation of the present invention. It will be apparent, however, to one skilled in the art, that the present invention may be practiced without these specific details. In other instances, well-known structures and devices are shown in block diagram form, rather than in detail, in order to avoid obscuring the present invention.

Some portions of the detailed descriptions that follow are presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussion, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

The present invention also relates to apparatus for performing the operations herein. This apparatus may be specially constructed for the required purposes, or it may comprise a general purpose computer selectively activated or reconfigured by a computer program stored in the computer. Such a computer program may be stored in a computer readable storage medium, such as, but is not limited to, any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions, and each coupled to a computer system bus.

The algorithms and displays presented herein are not inherently related to any particular computer or other apparatus. Various general purpose systems may be used with programs in accordance with the teachings herein, or it may prove convenient to construct more specialized apparatus to perform the required method steps. The required structure for a variety of these systems will appear from the description below. In addition, the present invention is not described with reference to any particular programming language. It will be appreciated that a variety of programming languages may be used to implement the teachings of the invention as described herein.

A machine-readable medium includes any mechanism for storing or transmitting information in a form readable by a machine (e.g., a computer). For example, a machine-readable medium includes read only memory (“ROM”); random access memory (“RAM”); magnetic disk storage media; optical storage media; flash memory devices; electrical, optical, acoustical or other form of propagated signals (e.g., carrier waves, infrared signals, digital signals, etc.); etc.

### Overview

Embodiments of the present invention include an asynchronous wake-up function that facilitates connectivity between a DSL modem and an asynchronous service even if a portion on the link (e.g., an L3 connection) between the two goes quiescent. The link, or portion thereof, may go quiescent when the DSL modem no longer needs to poll the network.

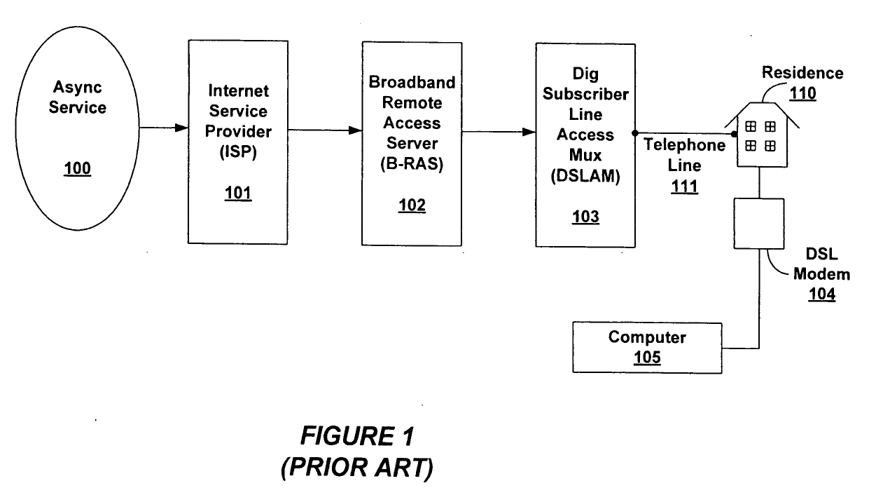

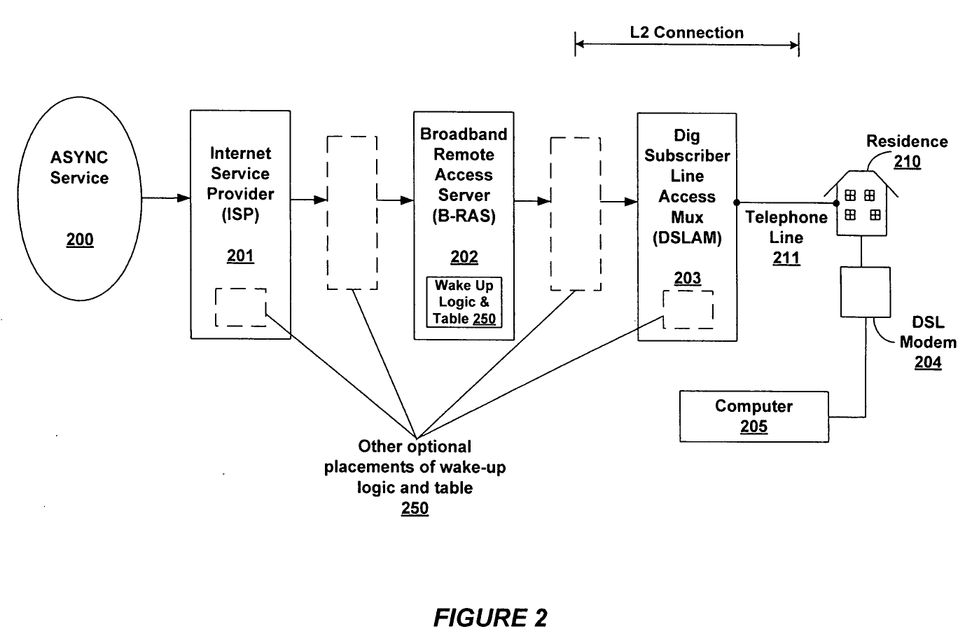

FIG. 2 illustrates a network arrangement that includes a digital subscriber line (DSL) modem. Referring to FIG. 2, as in FIG. 1, asynchronous service 200, ISP 201, B-RAS 202, DSLAM 203, link 211, DSL modem 204 and computer 205 cooperate to enable computer 205 to gain access to a network. The network arrangement includes a wake-up function to facilitate data transfer to DSL model 204 when an L3 connection no longer exists.

The asynchronous wake-up function operates by using a protocol at the L2 level of the protocol stack (where the L1 layer is the physical layer and the L3 layer is IP of the protocol stack). The L2 layer may be, for example, Ethernet. The L2 link layer extends between the asynchronous wake-up functionality and DSL modem 204. In one embodiment, the ascynchronous wake-up functionality includes wake-up logic and table 250 in B-RAS 202. Thus, the L2 link extends between B-RAS 202 and DSL modem 204.

If the IP, or L3, link is quiescent, the L1 and the L2 links still exist. Using the L2 connectivity that is in place between DSL modem 204 and B-RAS 202, in response to receiving data from asynchronous service 200, B-RAS 202 determines the destination of the data based on the IP address in the data received from asynchronous service 200.

A novel L2 protocol between the DSL modem 204 and B-RAS 202 enables B-RAS 202 to connect to DSL modem 204 to have the L3 connection re-initiated. In one embodiment, the protocol for negotiating the L2 link between B-RAS 202 and DSL modem 204 is an 802.1X protocol, which provides a point-to-point encrypted session in Layer-2. The 802.1X protocol is well-known in the art. This L2 link provides a secure channel for B-RAS 202 and DSL modem 204 to communicate. The content of the communication is new protocol containing syntax described herein that allows B-RAS 202 to request DSL modem 204 to re-establish its Layer-3 link.

When the L3 connection is up, DSL modem 204 provides its MAC and IP address to B-RAS 202 for use when the L3 connection between quiescent. The information is used by B-RAS 202 to address the message to the proper device using the L2 link. More specifically, when the L3 link becomes quiescent, B-RAS 202 uses a table that maps the IP address to a DSL modem 204 to wake up DSL modem 204 when data is received from asynchronous service 200 for computer 205. In other words, when an asynchronous request comes in from asynchronous service 200, B-RAS 202 looks up the destination IP address that is in the packet and determines that the data is addressed to DSL modem 204 based on the mapping. If the destination IP address does not appear in the table, the packet is dropped. However, if the IP address maps to an IP address in the wake up table, a wake-up message can be sent to DSL modem 204 over the secure L2 link. This message causes DSL modem 204 to reinitiate the PPPoE negotiations to reestablish the L3 connection. There are a number of other options for establishing a Layer-3 link between B-RAS 202 and DSL modem 204. These include, but are not limited to PPP over ATM, PPP over Frame-Relay, and the use of DHCP to establish a L3 link between B-RAS 202 and DSL modem 204.

In one embodiment, after the L3 connection is re-established, B-RAS 202 may reassign a new IP address to DSL modem 204. However, this is not required, and the same IP address can be used. In one embodiment, if the IP address has changed, B-RAS 202 notifies asynchronous service 200 using a SIP service.

Note that the use of this wake up to DSL modem includes additional functionality to perform the asynchronous wake up function, including additional functionality to receive the wake up message from B-RAS 202 in response thereto to cause the reestablishment of the L3 connection. Note that such cases, reestablishing the L3 connection is done in the same way that it is initially established between DSL modem 204 and B-RAS 202. DSL modem 204 is able to recognize the wake-up message and perform the wake-up. In one embodiment, DSL modem 204 supports the encrypted L2 channel with B-RAS 202 including receiving the wake-up message to wake up from the B-RAS.

Architecturally, the wake-up functionability may be positioned anywhere between ISP service 201 and the secure L2 link that goes to DSL modem 204. Thus, the functionality to cause the wake-up to occur is not included in B-RAS 202 and is a separate component or in another component. A component may be located between the ISP and the B-RAS, between the B-RAS and the DSLAM or in the DSLAM itself. These optional locations are shown in FIG. 2. However, the optional placements between B-RAS 202 and DSL modem 204 are less desirable than those between B-RAS 202 and asynchronous service 200.

In one embodiment, the wake up message includes information that specifies a device that is coupled to DSL modem 204. This would be useful to preserve battery power in a situation where multiple devices have entered a reduced power or sleep state and only one is awoken to receive the data, while leaving the others in the reduced power sleep state.

In one embodiment, the protocol from the secure L2 access link includes at least one packet having a header, applications-specific attributes, an identifier or version number and a checksum. The application's specific attributes may include type, length and/or data fields. In one embodiment, the information may be encrypted. The type field indicates the type, which may be, for example, binary, cleartext, XML, or anything in computer readable form. The type field may indicate the type of application. There may be a number of identifiers indicated in the packets.

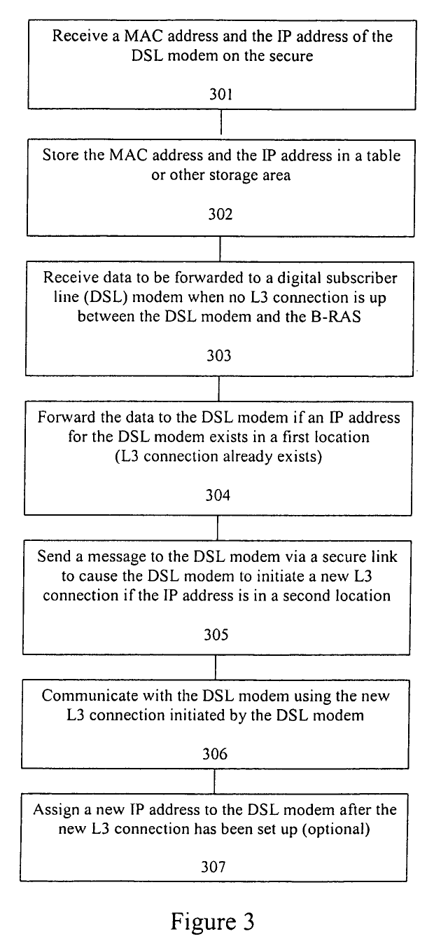

FIG. 3 is a flow diagram of one embodiment of a process performed by a broadband remote access server (B-RAS) (or other device similarly positioned with respect to an asynchronous service and a DSL modem) to cause the DSL modem to wake up. The process is performed by processing logic in such a server or device that may comprise hardware (circuitry, dedicated logic, etc.), software (such as is run on a general purpose computer system or a dedicated machine), or a combination of both.

Referring to FIG. 3, the process begins by processing logic receiving a MAC address and the IP address of the DSL modem on the secure L2 link (processing block 301). This registration process may occur while the DSL modem has an L3 connection with the B-RAS. More specifically, in one embodiment, this registration process from the DSL modem to the B-RAS occurs every time the DSL modem initiates its L3 link to the B-RAS. This need not occur on a secure link; a non-secure link may be used if security is not an issue.

Processing logic in the B-RAS stores the MAC address and the IP address in a table or other storage area (processing block 302). In one embodiment, the table is a wake-up table, which is separate from the host table mentioned below. In another embodiment, the wake-up table and the host table are combined into a single table (i.e., different parts of the same table).

Subsequently, processing logic receives data to be forwarded to the computer via a digital subscriber line (DSL) modem when no L3 connection is up between the DSL modem and the B-RAS (processing block 303). The data may be received from an asynchronous service via an ISP. The data includes an address (e.g., an IP address) assigned to the DSL modem to enable the B-RAS to determine the destination. Note that in this embodiment, the DSL modem is operating as a NAT firewall. However, if not, the wake-up operation may be performed in a different manner. For example, in one embodiment, when the B-RAS receives the L3 packet from the asynchronous service destined for the computer, the B-RAS performs an IP-route or IP-host look-up to determine how best to forward the packet. The result from this look-up yields the IP address of the DSL modem. The B-RAS detects that the Layer-3 link to the DSL modem is down and looks-up the MAC address of the DSL modem in the wake-up table so that it can initiate the wake-up protocol.

Processing logic forwards the data to the computer, via the DSL modem, if an IP address for the DSL modem exists in a first location (e.g., the host table). The presence of the IP address in the host table indicates that an L3 connection to the DSL modem exists (processing block 304). In an alternative embodiment, a field in the host table specifies whether the L3 connection is up.

In one embodiment, if the IP address is not stored in that first location (e.g., the host table), processing logic sends a message to the DSL modem via a secure link (e.g., a secure L2 link) to cause the DSL modem to initiate a new L3 connection if the IP address is in a second location (e.g., the wake-up table) (processing block 305). The presence of the IP address in the wake-up table and not in the host table indicates that a previously existing L3 connection to the DSL modem existed at one time but no longer is up. In an alternative embodiment, in which a field in the host table that specifies whether the L3 connection is up is checked and indicates the link is not up, processing logic sends the message as specified above.

In one embodiment, the secure link is a layer two (L2) link. In one embodiment, the secure link provides a secure channel, negotiated using the 802.1x protocol, over which the wake-up message is transmitted. Note that, in an alternative embodiment, the wake-up message is sent unencrypted on the L2 link. Although not required, this secure link may be the same link by which the B-RAS received the MAC and IP address of the DSL modem. In one embodiment, the message comprises a wake up message that causes the DSL modem to initiate PPPoE negotiations to reestablish an L3 connection.

Thereafter, processing logic in the B-RAS communicates with the DSL modem using the new L3 connection initiated by the DSL modem (processing block 306). As part of that communication, processing logic may assign a new IP address to the DSL modem after the new L3 connection has been set up (processing block 307).

In one embodiment, the wake-up message includes a header, one or more application specific attributes, information indicative of a version number corresponding to the message, and a checksum. The application specific attributes may comprise a message type, a message length and message data. All or a portion of the message may be encrypted.

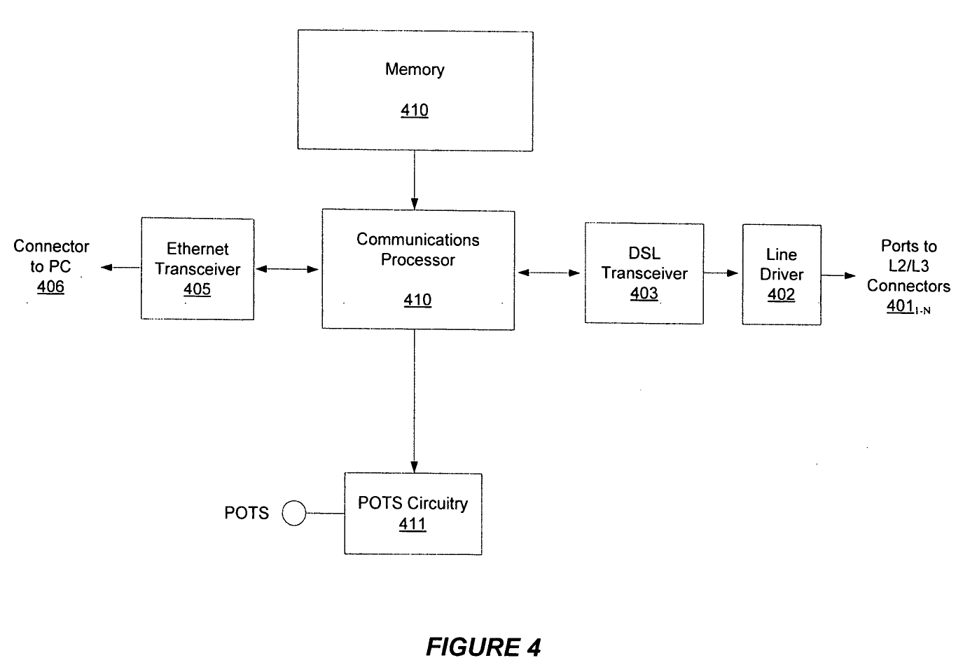

FIG. 4 is a block diagram of one embodiment of a DSL modem. Referring to FIG. 4, the DSL modem comprises multiple ports 401_{1-N}. One of the ports receives a wake-up message from a secure link (e.g., an L2 link). The message may come from a B-RAS or some other unit positioned between the asynchronous service and the other end of the secure link.

Ports 401_{1-N} are coupled to DSL transceiver 403 via line driver 402 to transfer data through ports 401_{1-N} as an output of the DSL modem and to receive data input into the DSL modem at ports 401_{1-N}.

Communications processor 410 is coupled to DSL transceiver 403 and coordinates and controls all communications of the DSL modem using instructions and data stored in memory 420. When executed, these instructions cause communications processor 410 to recognize a wake-up message and initiate, set up, and maintain both L2 and L3 connections described herein.

Communications processor 410 initiates L2 and L3 connections. The initiation of an L3 connection may occur in response to the wake-up message received over a secure L2 link (e.g., a secure L2 link operating according to an 802.1x protocol). Communications processor 410 is also responsible for initiating and negotiating the secure link to the B-RAS via, for example 802.1x. The wake-up message may be received from a broadband remote access server or other devices positioned at the other end of the L2 connection. The wake-up message is sent in response to receiving data after a previously existing L3 connection to the DSL modem is no longer up. In one embodiment, in response to the wake-up message, communications processor 410 initiates the new L3 connection by initiating PPPoE negotiations with the B-RAS to reestablish an L3 connection.

Prior to receiving the wake up message, communication processor 410 transfers (or causes the transfer of) the MAC address and the IP address assigned to the DSL modem on the secure L2 link to wake-up logic for storage in the wake-up table. The wake-up table may be stored in the B-RAS. That is, communications processor 410 sends the MAC and IP addresses itself. In an alternative embodiment, communications processor 410 signals another component internal to the DSL modem or external to the DSL modem to send such information.

Ethernet transceiver (or other types of transceiver) 405 is coupled to communication processor 410 and connector 406 to transfer information between communication processor 410 and a computer (e.g., the home computer of FIG. 2). Optionally, POTS circuitry 411 may be coupled to communication processor 410 and included in the DSL modem to facilitate connection to a POTS system.

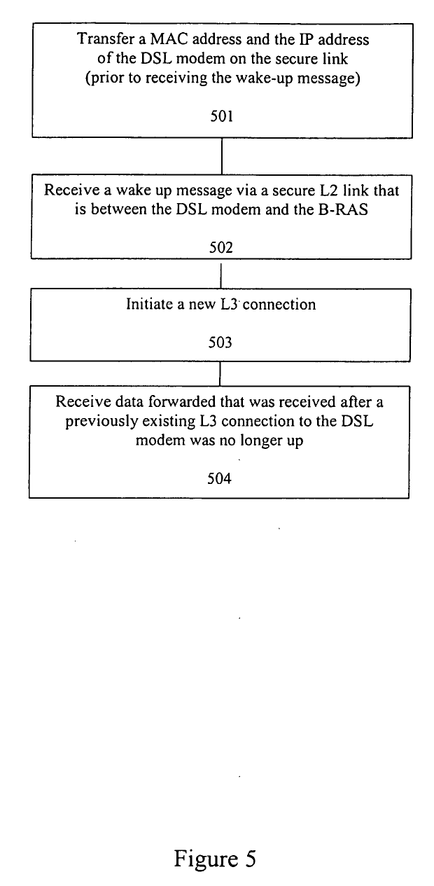

FIG. 5 is a flow diagram of one embodiment of a process for performing the wake-up functionality described herein. The process is performed by processing logic that may comprise hardware (circuitry, dedicated logic, etc.), software (such as is run on a general purpose computer system or a dedicated machine), or a combination of both.

Referring to FIG. 5, the process begins by processing logic transferring a MAC address and the IP address of the DSL modem on the secure link prior to receiving the wake-up message (processing block 501). Note that, in one embodiment, this is performed every time the DSL modem initiates an L3 connection to the B-RAS. In one embodiment, this occurs while a prior L3 connection exists between the DSL modem and a B-RAS over an L2 connection. In an alternative embodiment, this occurs over the secure L2 link that is used by the DSL modem to receive the wake-up message.

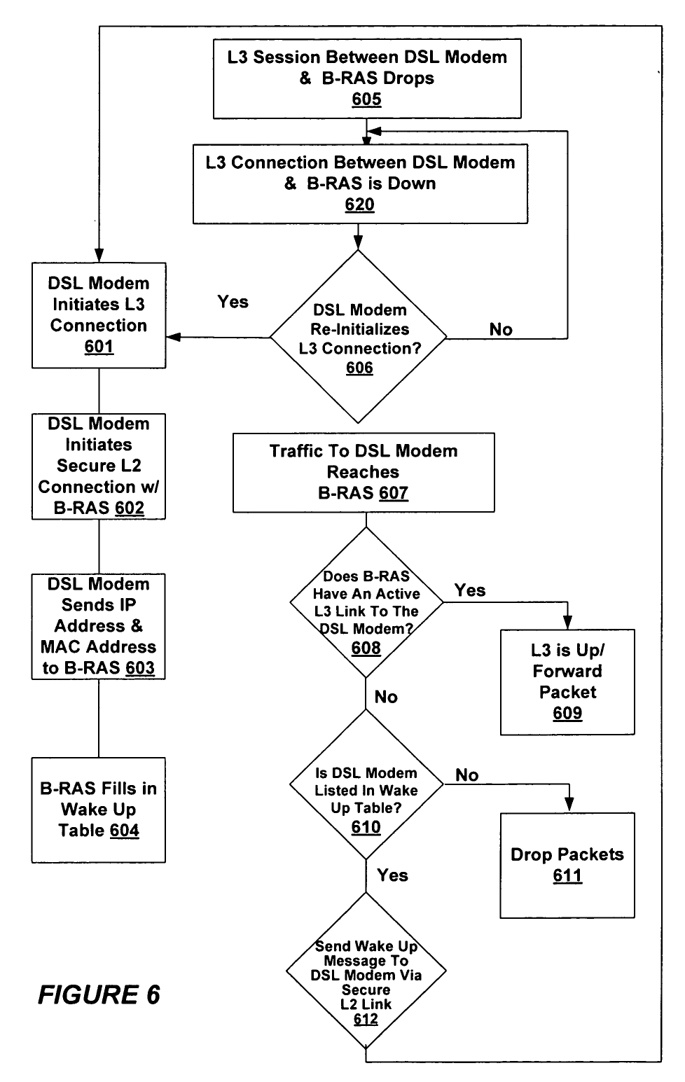

Next, at some time in the future, when an L3 connection no longer exists to the DSL modem, processing logic in the DSL modem receives a wake up message via a secure L2 link that is between the DSL modem and the B-RAS (processing block 502). Note that although the process of FIGS. 5 and 6 is described with reference to the wake-up logic being in the B-RAS, in alternative embodiments, another component positioned at the other end of the L2 connection opposite to the DSL modem may be used to perform the wake-up function.

In response to the wake-up message, processing logic initiates a new L3 connection (processing block 503). In one embodiment, processing logic initiates a new L3 connection by initiating PPPoE negotiations to reestablish an L3 connection.

After initiating the L3 connection, processing logic in the DSL modem receives data forwarded from a broadband remote access server that was received after a previously existing L3 connection to the DSL modem was no longer up and forwards it to a computer or other terminal device (processing block 504).

FIG. 6 is a flow diagram of one embodiment of a process for waking up a DSL connection between a DSL modem and a broadband remote access server (B-RAS). The process is performed by processing logic that may comprise hardware (e.g., circuitry, dedicated logic, etc.), software (such as is run on a general purpose computer system or a dedicated machine), or a combination of both.

Referring to FIG. 6, the processing logic in the DSL modem initiates a L3 connection (processing block 601). Next, processing logic in the DSL modem initiates a secure L2 connection with the B-RAS (processing block 602). After initiating the secure L2 connection, processing logic in the DSL modem sends an IP address and a MAC address to the B-RAS (processing block 603). Using the information, processing logic in the B-RAS fills in the wake-up table (processing block 604).

At some point, the L3 connection between the DSL modem and the B-RAS drops (processing block 605) at the L3 connection between the DSL modem and the B-RAS is down (processing block 620). Later, processing logic in the DSL modem then determines whether to reinitiate the L3 connection (processing block 606). This may occur because, for example, the DSL modem received data from the home computer that it needs to forward to the Internet. If so, processing logic transitions to processing block 601. If not, there is no L3 connection between the DSL modem and the processing returns to processing block 620.

Thereafter, traffic designated for the home computer, via the DSL modem, reaches the B-RAS (processing block 607). In response thereto, processing logic in the B-RAS determines whether the B-RAS has an active L3 connection to the DSL modem (processing block 608). The IP address being in the host table implies that the L3 connection between the B-RAS and the DSL modem is up. If it is, processing logic in the B-RAS forwards the packet to the home computer, via the DSL modem (processing block 609). If not, processing logic in the B-RAS tests whether the DSL modem is listed in the wake-up table (processing block 610). If not, processing logic in the B-RAS drops the packet (processing block 611). If it is, processing logic in the B-RAS sends the wake-up message to the DSL modem via the secure L2 link (processing block 612) and processing transitions to processing block 601 where the DSL modem initiates an L3 connection.

Whereas many alterations and modifications of the present invention will no doubt become apparent to a person of ordinary skill in the art after having read the foregoing description, it is to be understood that any particular embodiment shown and described by way of illustration is in no way intended to be considered limiting. Therefore, references to details of various embodiments are not intended to limit the scope of the claims which in themselves recite only those features regarded as essential to the invention.

We claim:

1. A method comprising:
receiving data to be forwarded to a computing device, via a digital subscriber line (DSL) modem, after a previously existing layer three (L3) connection to the DSL modem is no longer set up, the DSL modem being addressed via an Internet Protocol (IP) address specified in the data; and
sending a message to a DSL modem via a secure link to cause the DSL modem to initiate a new L3 connection if the IP address is available from a predetermined location.

2. The method defined in claim 1 further comprising communicating with the DSL modem using the new L3 connection initiated by the DSL modem.

3. The method defined in claim 1 wherein the predetermined location comprises a table mapping the IP address to the DSL modem, and further comprising:
determining whether the IP address is stored in the table, and wherein sending the message to the IP address occurs if the IP address from the data is in the table.

4. The method defined in claim 3 further comprising:
receiving a MAC address and the IP address on the secure link prior to receiving the data; and
storing the MAC address and the IP address in the table.

5. The method defined in claim 1 wherein the secure link is a layer two (L2) connection.

6. The method defined in claim 5 wherein the secure link is set up via a 802.1x protocol.

7. The method defined in claim 1 wherein the message comprises a wake up message to cause the DSL modem to initiate PPPoE negotiations to reestablish an L3 connection.

8. The method defined in claim 1 further comprising reassigning a new IP address to the DSL modem after the new L3 connection has been set up.

9. The method defined in claim 8 further comprising using a SIP service to notify an asynchronous service of the new IP address in response to reassigning the new IP address to the DSL modem.

10. The method defined in claim 1 wherein the message comprises a wake up message includes one or more of a header, one or more application-specific attributes, information indicative of a version number associated with the message, and a checksum.

11. The method defined in claim 10 wherein the one or more application-specific attributes comprises one or more of a message type, message length and message data.

12. The method defined in claim 1 wherein at least a portion of the message is encrypted.

13. The method defined in claim 1 wherein the data is from an asynchronous service.

14. A method comprising:
receiving data to be forwarded to a computing device, via a digital subscriber line (DSL) modem, that is addressed via an Internet Protocol (IP) address specified in the data;
forwarding the data to the IP address if data at a first location indicates that an L3 connection to the DSL connection exists; and
sending a message to the DSL modem via a secure link to cause the DSL modem to initiate a new L3 connection if the IP address is in a second location that is different than the first location, the IP address being in the second location indicating that a previously existing L3 connection to the DSL modem is no longer set up.

15. The method defined in claim 14 wherein the first location comprises a host table and the second location comprises a wake-up table.

16. The method defined in claim 14 wherein the first and second locations are located in different portions of the same table.

17. The method defined in claim 14 further comprising communicating with the DSL modem using the new L3 connection initiated by the DSL modem.

18. The method defined in claim 14 wherein the second location comprises a table mapping the IP address to the DSL modem, and further comprising:
determining whether the IP address is stored in the table, and wherein sending the message to the DSL modem occurs if the IP address from the data is in the table.

19. The method defined in claim 18 further comprising:
receiving a MAC address and the IP address on the secure link prior to receiving the data; and
storing the MAC address and the IP address in the table.

20. The method defined in claim 14 wherein the secure link is a layer two (L2) connection.

21. The method defined in claim 20 wherein the secure link is set up via a 802.1x protocol.

22. The method defined in claim 14 wherein the message comprises a wake up message to cause the DSL modem to initiate PPPoE negotiations to reestablish an L3 connection.

23. The method defined in claim 14 further comprising reassigning a new IP address to the DSL modem after the new L3 connection has been set up.

24. The method defined in claim 23 further comprising using a SIP service to notify an asynchronous service of the new IP address in response to reassigning the new IP address to the DSL modem.

25. The method defined in claim 14 wherein the message comprises a wake up message includes one or more of a header, one or more application-specific attributes, information indicative of a version number associated with the message, and a checksum.

26. The method defined in claim 25 wherein the one or more application-specific attributes comprises one or more of a message type, message length and message data.

27. The method defined in claim 14 wherein at least a portion of the message is encrypted.

28. The method defined in claim 14 wherein the data is from an asynchronous service.

29. An apparatus comprising:
an input to receive an indication that data for a device, which receives data via a digital subscriber line (DSL) modem, has been received after a previously existing layer three (L3) connection to the DSL modem is no longer set up, the DSL modem being addressed via an Internet Protocol (IP) address specified in the data;
a wake up data structure that stores a mapping of IP addresses to devices; and
a communications processor to cause a message to be sent to a DSL modem via a secure link to cause the DSL modem to initiate a new L3 connection if the IP address is stored in the wake-up table.

30. The apparatus defined in claim 29 further comprising communicating with the DSL modem using the new L3 connection initiated by the DSL modem.

31. The apparatus defined in claim 29 wherein the wake-up table maps a MAC address of the DSL modem to the IP address.

32. The apparatus defined in claim 29 wherein the secure link is a level two (L2) connection.

33. The apparatus defined in claim 32 wherein the secure link is set up via a 802.1x protocol.

34. The apparatus defined in claim 29 wherein the message comprises a wake up message to cause the DSL modem to initiate PPPoE negotiations to reestablish an L3 connection.

35. The apparatus defined in claim 29 wherein the communications processor reassigns a new IP address to the DSL modem after the new L3 connection has been set up.

36. The apparatus defined in claim 35 wherein the communications processor reassigns the new IP address to the DSL modem and notifies an asynchronous service of the new IP address using a SIP service.

37. The apparatus defined in claim 29 wherein the message comprises a wake up message includes one or more of a header, one or more application specific attributes, information indicative of a version number associated with the message, and a checksum.

38. The apparatus defined in claim 37 wherein the one or more application-specific attributes comprises one or more of a message type, message length and message data.

39. The apparatus defined in claim 29 wherein at least a portion of the message is encrypted.

40. The apparatus defined in claim 29 wherein the data is from an asynchronous service.

41. A DSL modem comprising:
a plurality of ports, at least one of the plurality of ports to receive a wake-up message via a secure L2 link;
a DSL transceiver coupled to the plurality of ports; and
a communications processor coupled to the DSL transceiver to initiate a new L3 connection in response to the wake-up message.

42. The DSL modem defined in claim 41 wherein the wake-up message is received from a broadband remote access server.

43. The DSL modem defined in claim 41 wherein the wake-up message is sent in response to receiving data after a previously existing layer three (L3) connection through one of the plurality of ports was no longer set up.

44. The DSL modem defined in claim 41 wherein the communication processor causes a transfer of a MAC address and the IP address assigned to the DSL modem on the secure L2 link prior to receiving the wake-up message.

45. The DSL modem defined in claim 41 wherein the secure L2 link is set up via a 802.1x protocol.

46. The DSL modem defined in claim 41 wherein the communications processor initiates the new L3 connection by initiating PPPoE negotiations to reestablish an L3 connection.

47. A method comprising:
receiving a wake up message via a secure L2 link; and
initiating a new L3 connection in response to the wake up message;
receiving data forwarded from a broadband remote access server that was received after a previously existing layer three (L3) connection to a DSL modem was no longer set up.

48. The method defined in claim 47 further comprising transferring a MAC address and the IP address on the secure link prior to receiving the wake-up message.

49. The method defined in claim 47 wherein the secure L2 link is set up via a 802.1x protocol.

50. The method defined in claim 47 wherein initiating the new L3 connection in response to the message comprises initiating PPPoE negotiations to reestablish an L3 connection.
